(19) United States
(12) Patent Application Publication
(10) Pub. No.: US 2014/0105473 A1
(43) Pub. Date: Apr. 17, 2014

(54) METHOD AND APPARATUS FOR SEGMENTING CONTOUR IN IMAGE

(71) Applicant: Samsung Electronics Co., Ltd., Suwon-si (KR)

(72) Inventors: Ye-Hoon KIM, Seoul (KR); Jong-Ha LEE, Yongin-si (KR); Yeong-Kyeong SEONG, Yongin-si (KR)

(73) Assignee: Samsung Electronics Co., Ltd., Suwon-si (KR)

(21) Appl. No.: 14/050,643

(22) Filed: Oct. 10, 2013

(30) Foreign Application Priority Data
Oct. 12, 2012 (KR) 10-2012-0113699
Apr. 22, 2013 (KR) 10-2013-0044436

(51) Int. Cl. G06T 7/00

(52) U.S. Cl. CPC G06T 7/0081
USPC 382/128

(57) ABSTRACT

A method and apparatus for segmenting a contour in an image is provided. The method for segmenting a contour in an image at a processor comprising: creating an initial individual by creating an arbitrary encoding value with respect to an image pixel; creating at least one offspring individual using the initial individual; selecting at least one offspring individual with high fitness from the created offspring individuals; and deriving an individual with highest fitness as a final contour from the selected offspring individuals.

### CROSS-REFERENCE TO RELATED APPLICATION

This application claims the benefit under 35 U.S.C. §119(a) of Korean Patent Application Nos. 10-2012-0113699 filed on Oct. 12, 2012, and 10-2013-0044436 filed on Apr. 22, 2013, the entire disclosure of which is incorporated herein by reference for all purposes.

### BACKGROUND

1. Field

The following description relates to a method and apparatus for segmenting a contour in an image where the contour of an image may be segmented through evolutionary computing.

2. Description of the Related Art

A computer-aided diagnosis (CAD) system for helping physicians detect malignant tumors in medical images such as X-ray, CT, ultrasound, and the like may extract a shape of a lesion by segmenting a contour of an object within an image.

As the segmentation of the contour is more accurately displayed, an accurate diagnosis concerning whether the corresponding lesion is malignant or benign may be made by the physician. An active contour model, which is representative of many studies for segmenting the contour of the object within the image, may be used for effectively and accurately segmenting a contour of an object within an image. When using a region growing method of the active contour model, a contour is found through gradual and repetitive expansion and contraction from an initial contour, and therefore there is a possibility that local optimum contour may be found and dependence on a position of the initial contour is increased.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method for segmenting a contour in an image at a processor includes creating an initial individual by creating an arbitrary encoding value with respect to an image pixel; creating at least one offspring individual using the initial individual; selecting at least one offspring individual with high fitness from the created offspring individuals; and deriving an individual with highest fitness as a final contour from the selected offspring individuals.

The method for segmenting a contour in an image may include classifying pixels within a grid into contour pixels and non-contour pixels to binary-encode the pixels.

The method for segmenting a contour in an image may include encoding a relative direction between adjacent pixels within the grid.

The method for segmenting a contour in an image may include setting an arbitrary pixel as a starting point and calculating its initial coordinates, and sequentially encoding relative directions of adjacent pixels from the set starting point.

The method for segmenting a contour in an image may include creating the offspring individual using at least one of a crossover operation or a mutation operation.

The method for segmenting a contour in an image may include performing the crossover operation with respect to at least one crossover point in a horizontal direction or a vertical direction.

The method for segmenting a contour in an image may include performing the crossover operation based on a reference pixel line when grid sizes of initial individuals are different from each other.

The method for segmenting a contour in an image may include determining fitness of each of the created offspring individuals, and selecting the at least one offspring individual with high fitness from the created offspring individuals.

The method for segmenting a contour in an image may include selecting the at least one offspring individual in a roulette wheel selection.

The method for segmenting a contour in an image may include selecting the at least one offspring individual in a tournament selection.

The method for segmenting a contour in an image may include selecting the at least one offspring individual in a rank-based selection.

The method for segmenting a contour in an image may include determining whether a termination condition is satisfied, and deriving the individual with the highest fitness as the final contour when the termination condition is satisfied.

The method for segmenting a contour in an image may include creating at least one new offspring individual having the selected at least one offspring individual as a parent generation, when the termination condition is not satisfied.

In another general aspect, an apparatus for segmenting a contour in an image including an initial population creator configured to create an initial individual by creating an arbitrary encoding value with respect to an image pixel; an offspring population creator configured to create at least one offspring individual using the initial individual; an offspring selector configured to select at least one offspring individual with high fitness from the created offspring individuals; and a contour selector configured to derive an individual with highest fitness as a final contour from the selected offspring individuals.

The apparatus for segmenting a contour in an image may include a fitness estimator configured to determining fitness of each of the created offspring individuals, and wherein the offspring selector is further configured to select the at least one offspring individual with high fitness from the created offspring individuals.

The apparatus for segmenting a contour in an image may include a termination controller configured to determine whether a termination condition is satisfied, and wherein the contour selector is configured to derive the individual with the highest fitness as the final contour when the termination condition is satisfied.

The apparatus for segmenting a contour in an image wherein the offspring creator may be further configured to create at least one new offspring individual having the selected at least one offspring individual as a parent generation, when the termination condition is not satisfied.

Other features and aspects will be apparent from the following detailed description, the drawings, and the claims.

### BRIEF DESCRIPTION OF THE DRAWINGS

FIG. 1 is a diagram illustrating an example of a method for segmenting a contour.

FIG. 2 is a diagram illustrating an example of an apparatus for segmenting a contour.

FIG. 3 is a diagram illustrating an example of initial object generation using binary encoding.

FIGS. 4A to 4C are diagrams illustrating examples for creating an initial individual using direction encoding.

FIGS. 5A to 5C are diagrams illustrating examples for crossover operation in a case of binary encoding.

FIG. 6 is a diagram illustrating an example of a mutation operation in a case of binary encoding.

FIG. 7 is a diagram illustrating an example of a crossover operation in a case of direction encoding.

FIG. 8 is a diagram illustrating an example of a mutation operation in a case of direction encoding.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be apparent to one of ordinary skill in the art. Also, descriptions of well-known functions and constructions may be omitted for increased clarity and conciseness. Throughout the drawings and the detailed description, an individual refers to a random possible solution corresponding to a contour of an object within an image, and a population refers to a set of individuals, i.e., a set of several possible solutions.

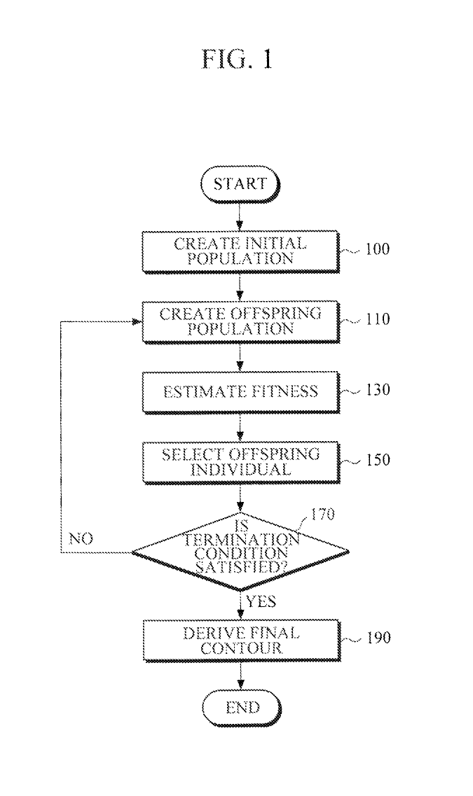

FIG. 1 is diagram illustrating an example of a method for segmenting a contour in an image. The operations in FIG. 1 may be performed in the sequence and manner as shown, although the order of some operations may be changed or some of the operations omitted without departing from the spirit and scope of the illustrative examples described. Many of the operations shown in FIG. 1 may be performed in parallel or concurrently.

Referring to FIG. 1, in 100, the method for segmenting the contour in the image may create at least one initial individual by creating an arbitrary encoding value with respect to an image pixel. As a non-exhaustive example only, encoding with respect to the image pixel may be performed using binary encoding or direction encoding. In addition, when the arbitrarily created encoding value may not completely represent a contour, a complete closed curve may be created using a variety of methods such as, for example, gift-wrapping, graham scan, and quick hull. The initial individual may form an initial population and the initial population may be a parent generation for creating a next generation of population. The number of the initial individuals created in 100 may be arbitrarily determined by a user.

In 110, at least one offspring individual from the initial population may be created. In this instance, the offspring individual may be created from at least one parent individual using an operation such as, for example, a crossover operation or a mutation operation. The number of the offspring individuals may be arbitrarily determined by a user.

In 130, the fitness with respect to each of the offspring individuals from an offspring population may be calculated. In 150, at least one offspring individual with high fitness may be selected. In this instance, the fitness may indicate how closely does the offspring individual resemble the actual contour, and determination of the fitness may be performed by a variety of fitness functions. In addition, each parameter of the fitness function may use an optimized value that has been previously learned. According to an example, the fitness function may use an energy function such as, for example, Equation 1.

$$F ( c 1 , c 2 , C ) = μ \cdot Length ( C ) + v \cdot Area ( inside ( C ) ) + λ 1 {\int }_{inside ( C )} {\vert {u}_{0} ( x , y ) - c 2 \vert}^{2} d x d y + λ 2 {\int }_{outside ( C )} {\vert {u}_{0} ( x , y ) - c 2 \vert}^{2} d x d y ↵ \qquad [ Equation 1 ]$$

In Equation 1, inside (C) and outside (C) denote an inner region and an outer region of a contour, c1 and c2 denote average color values of the inner and outer regions of the contour, and μ, v, λ1, and λ2 denote fixed parameters where μ, v≧0, and λ1, λ2>0. Each of the parameters μ, v, λ1, and λ2 uses an optimized value of an estimation function that has been previously learned. In addition, u₀(x,y) denotes a color value in a specific position.

In Equation 1, characteristics of a contour of an object are defined as an energy function. A contour that distinguishes the inner and outer regions of the contour more may have a lower energy function, and an individual whose energy function is 0 has highest fitness.

Because Equation 1 is merely an example, fitness may be estimated utilizing a variety of functions that can estimate characteristics of the contour. Selection of the offspring individuals by estimation of the fitness may be performed by a variety of methods such as, for example, a roulette wheel method, a tournament method, or a rank-based selection. In the roulette wheel method, a predetermined number of individuals survive with a probability that is proportional to the fitness. In the tournament method, fitness is compared between offspring individuals in a tournament manner and a predetermined number of offspring individuals with high fitness are selected. In the rank-based selection, offspring individuals having a predetermined rank or more are selected from the offspring individuals. The number of the offspring individuals selected from the offspring population may be set by a user, or may be variably set based on a computation amount and required accuracy of segmentation of the contour.

In 170, the offspring individual is selected when a termination condition is satisfied, and the individual with the highest fitness may be derived as a final contour in 190. In this example, the termination condition may be used to determine whether a new offspring generation is created using the offspring individual selected from the offspring population, based on a variety of conditions such as, for example, a case in which creation of a predetermined generation is completed (for example, completion of creation of 100 generation) or a case in which an individual having fitness of a predetermined value or less is created, or based on a combination of one or more conditions.

On the other hand, when the termination condition is not satisfied in 170, the at least one offspring individual selected from the offspring population may form a new parent population for creating a next generation, and the creation of the offspring generation through evolutionary computing may be repeated until the termination condition is satisfied.

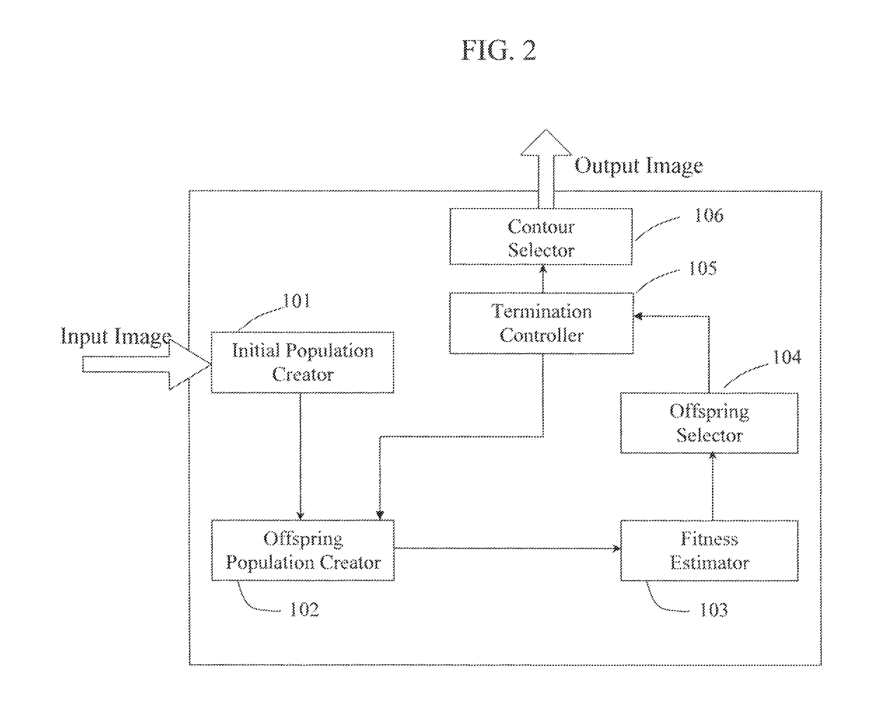

FIG. 2 is a diagram illustrating an example of an apparatus for segmenting a contour 10. Referring to FIG. 2, the apparatus for segmenting a contour 10 includes an initial population creator 101, an offspring population creator 102, a fitness estimator 103, an offspring selector 104, a termination controller 105, and a contour selector 106.

Only components related to the present example are illustrated in the apparatus for segmenting a contour 10 of FIG. 2. Thus, those skilled in the art may understand that general components except for components illustrated in FIG. 2 may be further included. For example, the apparatus for segmenting a contour 10 may include an interface unit (not illustrated). The interface unit may be responsible for inputting and outputting input information regarding a user and an image. The interface unit may include a network module for connection to a network and a universal serial bus (USB) host module for forming a data transfer channel with a mobile storage medium, depending on a function of the apparatus for segmenting a contour 10. In addition, the interface unit includes an input/output device such as a mouse, a keyboard, a touch screen, a monitor, a speaker, and a software module for running the input/output device. In addition, the apparatus for segmenting a contour 10 may further include a storage unit (not illustrated) that stores models that are described below. The storage unit may include, for example, a hard disk drive (HDD), a read only memory (ROM), a random access memory (RAM), a flash memory, or a memory card as an ordinary storage medium.

The initial population creator 101, the offspring population creator 102, the fitness estimator 103, the offspring selector 104, the termination controller 105, and the contour selector 106 that are illustrated in FIG. 2 may correspond to one or a plurality of processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processor may be implemented as an array of numerous logic gates and may also be implemented as a combination of a general-purpose microprocessor with a memory unit which stores a program that may be executed by the microprocessor. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The initial population creator 101 creates at least one initial individual by creating an arbitrary encoding value with respect to an image pixel. The offspring population creator 102 creates at least one offspring individual from the initial population. The offspring individual may be created from the parent individual using an operation such as, for example, a crossover operation or a mutation operation. The fitness estimator 103 may calculate the fitness with respect to each of the offspring individuals from an offspring population. The offspring selector 104 selects at least one offspring individual with high fitness from the offspring individuals. The termination controller 105 verifies whether the termination condition is satisfied. If the termination condition is satisfied, the contour selector 106 may select the individual with the highest fitness as the final contour. If the termination condition is not satisfied, at least one offspring individual selected from the offspring population may form a new parent population for creating a next generation, and the creation of the offspring generation through evolutionary computing may be repeated until the termination condition is satisfied.

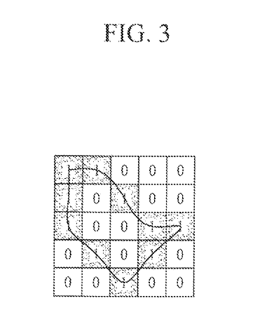

FIG. 3 is a diagram illustrating an example of initial object generation using binary encoding. Referring to FIG. 3, an arbitrary contour may be created by respectively encoding pixels corresponding to the contour and pixels not corresponding to the contour into 1 and 0. The arbitrary contour may be created by arbitrarily encoding each of the pixels within a grid with a predetermined size into 1 or 0. In the example shown in FIG. 3, a size of the grid is 5×5, and pixels corresponding to the contour and pixels not corresponding to the contour are respectively encoded into 1 and 0, but the encoding may be reversed. The size of the grid for determining the contour may be arbitrarily set by a user.

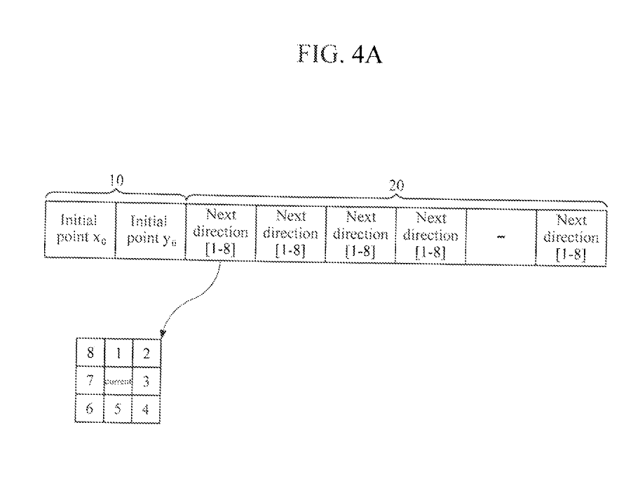

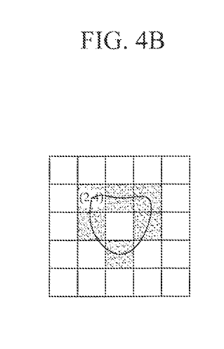

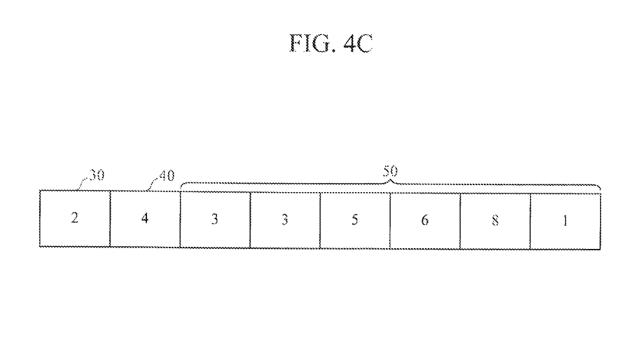

FIGS. 4A to 4C are diagrams illustrating examples for creating an initial individual using direction encoding. Referring to FIG. 4A, an arbitrary contour may be created by encoding a relative direction between pixels. An initial coordinates 10 of a starting point are obtained using one of the pixels within a grid as the starting point, relative directions of the next pixels are arranged from the initial coordinates 10. In this instance, the starting point may arbitrarily select one of the pixels corresponding to the contour. As shown in FIG. 4A, for directions between pixels, a 12 o'clock direction from the current pixel is designated as 1, and directions may be sequentially designated as 2 to 8 in a clockwise direction. Other directions and designations may be used without departing from the spirit and scope of the illustrative examples described. The size of the grid for determining the contour may be arbitrarily set by a user.

Referring to FIG. 4B, initial coordinates may be obtained using an arbitrary pixel as a starting point ((2, 4) in the shown example). An arbitrary pixel around the current pixel may be selected using a pixel corresponding to the initial coordinates as the starting point, and relative directions between the current pixel and the selected pixel may be sequentially arranged, and encoding may be performed as shown in FIG. 4C. Referring to FIG. 4C, real values of x and y coordinates of the pixel corresponding to the starting point of the contour are arranged (30, 40), and the relative directions between the arbitrarily selected pixels are sequentially arranged (50) starting from the pixel corresponding to the starting point, thereby encoding the contour. As a non-exhaustive example only, when the start and end pixels are not adjacent to each other based on the result of the direction encoding, a closed curved line may be created by connecting the first point and the end point. As another example, when the contour obtained by the direction encoding crosses an existing line, an exploration space may be reduced while continuing to explore the contour by converting the contour into a closed curved line or a circular contour.

When the creation of a parent population is completed, an offspring population may be created through evolutionary computing in 110. In this instance, the evolutionary computing is used to create offspring individuals using at least one parent individual, and may include operations, such as, for example, a crossover operation or a mutation operation. When the offspring individuals are created through the evolutionary computing, a variety of offspring individuals having different positions and shapes from those of the parent individuals are created, and therefore exploration may be independent of a position and a shape of the initial contour when exploring the contour. Accordingly, unlike an existing active contour model, a global optimum that is different from a local optimum may be obtained, thereby enhancing accuracy of the segmentation of the contour.

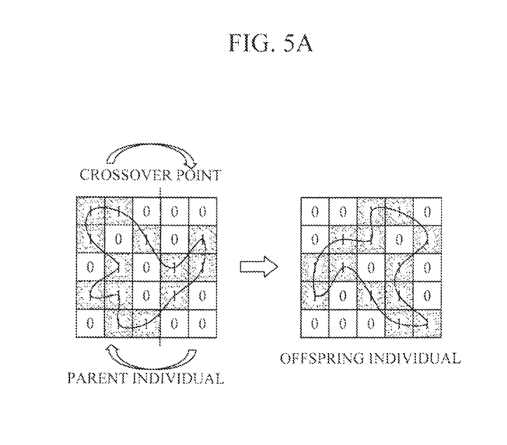

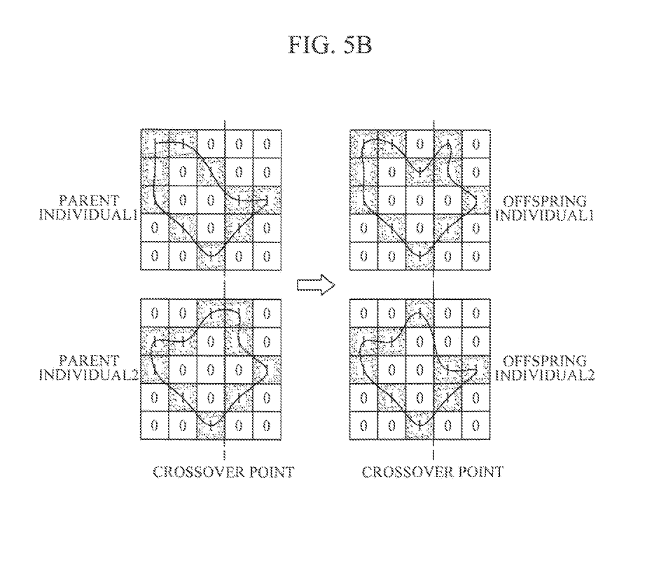

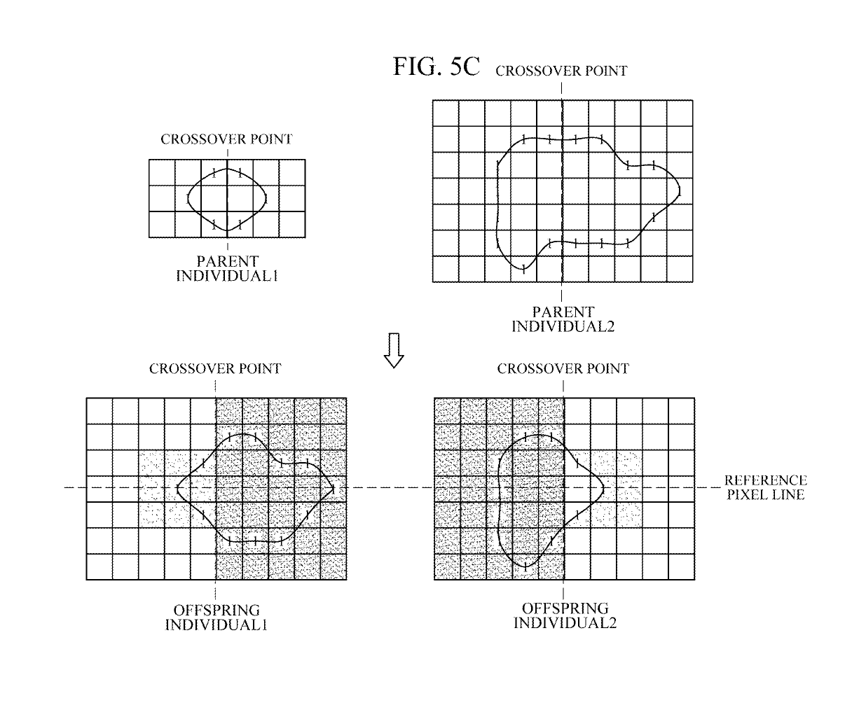

FIGS. 5A to 5C are diagrams illustrating examples of a crossover operation in a case of binary encoding. FIG. 5A discloses an example where an offspring individual is created from a single parent individual through crossover operation. As shown in FIG. 5A, a new offspring individual whose contour is different from that of the parent individual may be created by switching the position of an array of pixels from either side of the crossover point. The array of pixels on the right of the crossover point may be moved to the left of the crossover point, and an array of pixels on the left of the crossover point may be moved to the right of the crossover point. Thereby, switching the array of pixels from either side of the crossover point in the single parent individual to create the offspring individual. In this instance, the crossover point may be arbitrarily set, and at least one crossover point may be present in a horizontal direction or a vertical direction.

FIG. 5B shows an example in which two offspring individuals, whose contour are different from those of the parent individuals are created from two parent individuals by crossover. As shown in FIG. 5B, an array of pixels on the right of the crossover point in Parent Individual 1 and Parent Individual 2 may be switched with each other to create Offspring Individual 1 and Offspring Individual 2. For example, the array of pixels on the right of the crossover point in Parent Individual 1 may replace the array of pixels on the right of the crossover point in Parent Individual 2 to create Offspring Individual 2. Likewise, the array of pixels on the right of the crossover point in Parent Individual 2 may replace the array of pixels on the right of the crossover point in Parent Individual 1 to create Offspring Individual 1. In this instance, the crossover point may be arbitrarily set, and at least one crossover point may be present in a horizontal direction or a vertical direction.

In FIG. 5C, an example is shown where offspring individuals, whose contour's shapes are different from those of the parent individuals, are created from parent individuals having different grid sizes through crossover. As shown in FIG. 5C, when performing a crossover operation with respect to two parent individuals having different grid sizes, the array of pixels of each of the parent individuals on either side of the crossover point are separated. For example, the array of pixels on the right of the crossover point in Parent Individual 1 may be joined with the array of pixels on the left of the crossover point in Parent Individual 2 to create Offspring Individual 2. Likewise, the array of pixels on the left of the crossover point in Parent Individual 1 may be joined with the array of pixels on the right of the crossover point in Parent Individual 2 to create Offspring Individual 1. In this instance, the reference pixel line may be set in an arbitrary position such as an upper portion, a lower portion, and a middle portion.

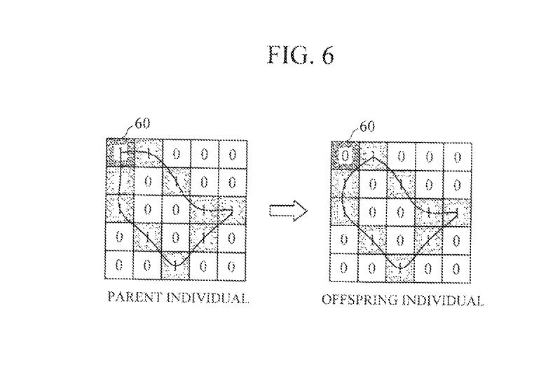

FIG. 6 is a diagram illustrating an example of a mutation operation in a case of binary encoding. Referring to FIG. 6, by changing an encoding value of an arbitrary pixel in a parent individual from 1 to 0 or from 0 to 1, an offspring individual whose contour's shape is different from that of the parent individual may be created. In an example shown in FIG. 6, an encoding value of a pixel 60 corresponding to a contour of a parent individual is changed from 1 to 0, and therefore an offspring individual having a different contour from the parent individual may be created. A probability of occurrence of mutation may be arbitrarily designated by a user, and mutation may be created from at least one arbitrary pixel of a single parent individual.

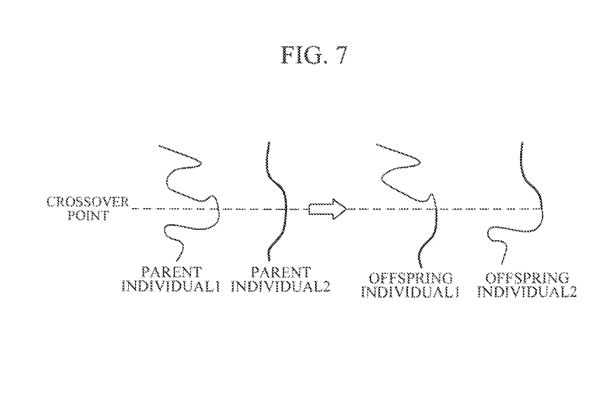

FIG. 7 is a diagram illustrating an example of a crossover operation in a case of direction encoding. Referring to FIG. 7, when a contour is encoded through direction encoding, offspring individuals whose contour's shapes are different from those of two parent individuals may be created by crossing the two parent individuals with respect to an arbitrary crossover point. As shown in the example of FIG. 7, when Parent Individuals 1 and 2 are created using direction encoding, portions of the Parent Individuals 1 and 2 indicating directions of pixels are exchanged with respect to a crossover point, and therefore Offspring Individuals 1 and 2 each having a new contour may be created.

Initial coordinates that is a position of a starting point in the direction encoding may also cross with respect to the crossover point, thereby creating new coordinates. Accordingly, an exploration region of a contour desired to be explored is independent of the initial position of the parent individual, and therefore it is possible to explore the contour with respect to the entire exploration region. The crossover point may be arbitrarily set, and at least one crossover point may be present, and therefore the offspring individual whose contour's position and shape are different from those the parent individual may be created.

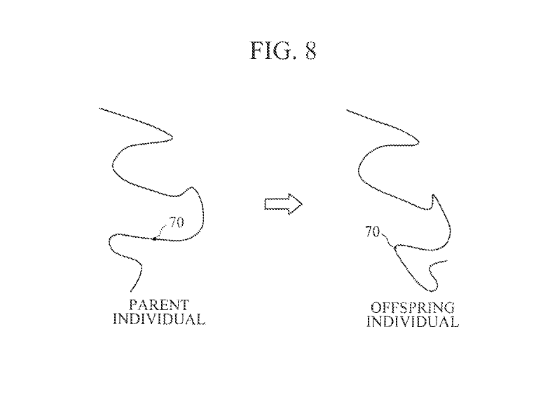

FIG. 8 is a diagram illustrating an example of a mutation operation in a case of direction encoding. Referring to FIG. 8, when a parent individual is created by direction coding, a new offspring individual may be created by changing an encoding value of a direction of a next pixel in a specific pixel. As shown in the example of FIG. 8, the offspring individual different from the parent individual may be created by changing the encoding value in the specific point 70 of the parent individual created by the direction encoding.

When mutation is created in a portion indicating an initial position among encoding values of the parent individual created by the direction encoding, an offspring individual having the same shaped contour as the parent individual and a position different from the parent individual may be created. For example, when the coordinates of the initial position of the parent individual are (4, 5), an offspring individual having the initial position such as (3, 5) or (4, 6) may be created by the mutation operation. Accordingly, an exploration region of a contour desired to be explored is independent of the initial position of the parent individual, and therefore it is possible to explore the contour with respect to the entire exploration region. A probability of occurrence of mutation may be designated by a user, and at least one mutation may be created in a single parent individual.

The methods described above can be written as a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device that is capable of providing instructions or data to or being interpreted by the processing device. The software also may be distributed over network coupled computer systems so that the software is stored and executed in a distributed fashion. In particular, the software and data may be stored by one or more non-transitory computer readable recording mediums. The non-transitory computer readable recording medium may include any data storage device that can store data that can be thereafter read by a computer system or processing device. Examples of the non-transitory computer readable recording medium include read-only memory (ROM), random-access memory (RAM), CD-ROMs, magnetic tapes, USBs, floppy disks, hard disks, optical recording media (e.g., CD-ROMs, or DVDs), and PC interfaces (e.g., PCI, PCI-express, WiFi, etc.). In addition, functional programs, codes, and code segments for accomplishing the example disclosed herein can be construed by programmers skilled in the art based on the flow diagrams and block diagrams of the figures and their corresponding descriptions as provided herein.

The apparatuses described herein may be implemented using hardware components. The hardware components may include, for example, controllers, sensors, processors, generators, drivers, and other equivalent electronic components. The hardware components may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The hardware components may run an operating system (OS) and one or more software applications that run on the OS. The hardware components also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a hardware component may include multiple processors or a processor and a controller. In addition, different processing configurations are possible, such a parallel processors.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method for segmenting a contour in an image at a processor, the method comprising:
creating an initial individual by creating an arbitrary encoding value with respect to an image pixel;
creating at least one offspring individual using the initial individual;
selecting at least one offspring individual with high fitness from the created offspring individuals; and
deriving an individual with highest fitness as a final contour from the selected offspring individuals.

2. The method of claim 1, wherein the creating of the initial individual comprises classifying pixels within a grid into contour pixels and non-contour pixels to binary-encode the pixels.

3. The method of claim 1, wherein the creating of the initial individual comprises encoding a relative direction between adjacent pixels within the grid.

4. The method of claim 3, wherein encoding the relative direction between adjacent pixels comprises:
setting an arbitrary pixel as a starting point and calculating its initial coordinates, and
sequentially encoding relative directions of adjacent pixels from the set starting point.

5. The method of claim 1, wherein the creating of the offspring individual comprises creating the offspring individual using at least one of a crossover operation or a mutation operation.

6. The method of claim 5, wherein the creating of the offspring individual further comprises performing the crossover operation with respect to at least one crossover point in a horizontal direction or a vertical direction.

7. The method of claim 6, wherein the creating of the offspring individual further comprises performing the crossover operation based on a reference pixel line when grid sizes of the initial individuals are different from each other.

8. The method of claim 1, wherein the selecting of the offspring individual comprises:
determining fitness of each of the created offspring individuals, and
selecting the at least one offspring individual with high fitness from the created offspring individuals.

9. The method of claim 1, wherein the selecting of the offspring individuals comprises selecting the at least one offspring individual in a roulette wheel selection.

10. The method of claim 1, wherein the selecting of the offspring individuals comprises selecting the at least one offspring individual in a tournament selection.

11. The method of claim 1, wherein the selecting of the offspring individuals comprises selecting the at least one offspring individual in a rank-based selection.

12. The method of claim 1, wherein the deriving of the individual as the final contour comprises:
determining whether a termination condition is satisfied, and
deriving the individual with the highest fitness as the final contour when the termination condition is satisfied.

13. The method of claim 11, further comprising creating at least one new offspring individual having the selected at least one offspring individual as a parent generation, when the termination condition is not satisfied.

14. An apparatus for segmenting a contour in an image, the apparatus comprising:
an initial population creator configured to create an initial individual by creating an arbitrary encoding value with respect to an image pixel;
an offspring population creator configured to create at least one offspring individual using the initial individual;
an offspring selector configured to select at least one offspring individual with high fitness from the created offspring individuals; and
a contour selector configured to derive an individual with highest fitness as a final contour from the selected offspring individuals.

15. The apparatus of claim 14, further comprising:
a fitness estimator configured to determining fitness of each of the created offspring individuals, and
wherein the offspring selector is further configured to select the at least one offspring individual with high fitness from the created offspring individuals.

16. The apparatus of claim 14, further comprising:
a termination controller configured to determine whether a termination condition is satisfied, and
wherein the contour selector is configured to derive the individual with the highest fitness as the final contour when the termination condition is satisfied.

17. The apparatus of claim 16, wherein the offspring creator is further configured to create at least one new offspring individual having the selected at least one offspring individual as a parent generation, when the termination condition is not satisfied.
